(19) United States
(12) Patent Application Publication
(10) Pub. No.: US 2023/0391936 A1
(43) Pub. Date: Dec. 7, 2023

(54) ACTINICALLY CURABLE COMPOSITIONS FOR ABLATIVE CARBON-BONDED COMPOSITES AND ADDITIVE MANUFACTURING METHOD USING SUCH COMPOSITIONS

(71) Applicant: Arkema France, Colombes (FR)

(72) Inventors: Kyle SNOW, Exton, PA (US); Sean NUNEZ, Exton, PA (US); William WOLF, Exton, PA (US)

(21) Appl. No.: 18/032,844

(22) PCT Filed: Oct. 20, 2021
(86) PCT No.: PCT/IB2021/000716

§ 371 Date: Apr. 20, 2023

Related U.S. Application Data
(60) Provisional application No. 63/094,544, filed on Oct. 21, 2020.

(51) Int. Cl. C08F 220/30; C08F 2/48; C08K 7/06; C08K 5/5397; C08L 33/10; C08J 3/28

(52) U.S. Cl. CPC C08F 220/30; C08F 2/48; C08K 7/06; C08J 2333/10; C08L 33/10; C08J 3/28; C08K 5/5397

(57) ABSTRACT

An actinically curable composition includes at least one aromatic, actinically curable component a), at least one actinically curable monomer b) as a diluent, an opaque reinforcement c) and at least one photoinitiator d). After curing and upon pyrolysis, the actinically curable composition may provide more than 18 weight % char, by weight of the component a), the actinically curable monomer b) and the photoinitiator d) after curing. The opaque reinforcement may be continuous fibers. A method of making a three dimensionally printed carbon bonded composite article from the actinically curable composition using digital light projection, stereolithography or multi jet printing is also provided.

### FIELD OF THE INVENTION

This invention relates to actinically curable compositions. The actinically curable compositions include at least one aromatic, actinically curable component selected from (meth)acrylate oligomers, epoxy-functionalized compounds, oxetane-functionalized compounds, and mixtures thereof, and at least one actinically curable monomer as a diluent. The curable compositions also include an opaque reinforcement and at least one photoinitiator. After curing and upon pyrolysis, the actinically cured ablative composite may be capable of creating more than 18 weight % char, by weight of the component selected from (meth)acrylate oligomers, epoxy-functionalized compounds, oxetane-functionalized compounds, and mixtures thereof, the diluent and the photoinitiator. The opaque reinforcement may be continuous fibers. The invention also relates to methods of making three dimensionally printed ablative composites articles from the actinically curable compositions using continuous fibers co-deposited with the actinically curable composition, digital light projection, stereolithography or multi jet printing. The actinically curable compositions may be used to coat any number of continuous reinforcements (e.g., separate fibers, tows, rovings, socks, and/or sheets of continuous material) to produce a three-dimensional composite. The invention further relates to additive manufacturing methods using such actinically curable compositions.

### BACKGROUND

The references disclosed in this section are merely for background information and are not to be considered as prior art.

A composite is a material made from multiple different material components that, when put together, have property enhanced above the same property of the individual components. For example, a composite material may be lighter, stronger, stiffer, harder, tougher, more heat resistant, more heatflux capabilities, etc. than the constituent materials used to make the composite material. One example application of a composite is in high-temperature environments, where weight and strength are important considerations. This can include aerospace applications, such as components of a flight or space vehicle engine, heat shields, and rocket nozzles, nuclear energy applications, e.g. fuel rod insulators.

Multiple types of composites may be used in high-temperature environments. These types include, among others, carbon bonded fiber composites (CBFCs) such as carbon bonded carbon and carbon bonded ceramic composites, and ceramic matrix composites (CMCs) such as ceramic bonded carbon and ceramic bonded ceramic composites. While these types of composites may provide many benefits, their traditional fabrication may be difficult, time consuming and expensive. Accordingly, their uses may be limited.

For example, a traditional fabrication process for making either a carbon CBFC or a CMC component includes first coating fibers (e.g., carbon or ceramic fibers) with a material that promotes anisotropic performance of the fibers. Coated fibers are then laid by hand into a mold or wrapped around a mandrel, both having a nondescript shape and a size significantly greater than an intended final size of the desired component. The fibers are then saturated with a resin, and the mold, fibers and resin are placed into an oven and heated to a temperature at which the resin pyrolysis forms carbon or a ceramic. The pyrolysis creates voids within the resulting structure that must then be filled with more resin. The mold is again placed into the oven and heated, and the process is repeated until a porosity of the resulting structure is sufficiently low. At this point in time, a generically shaped block of composite material is produced, which must then be subtractively machined to a desired net shape. Because of the hardness and/or brittleness of the composite material (particularly CMCs), the machining can be difficult.

While ablative composites perform well in certain applications, the process to fabricate them is labor, time and material exhaustive, particularly for composites that include continuous fiber reinforcements. This makes these composite components expensive and limits their applications. Additive manufacturing (3D printing) systems and methods are uniquely configured to address these issues. There are several different types of additive manufacturing methods available, but the most attractive in terms of speed and desirable final properties of the ablative composites are those that are utilize actinic radiation to cure the resin that is the precursor (prior to the pyrolyzing step) to the carbon matrix of ablative composites.

Documents describing ablative composites are summarized below.

International Patent Application Publication No. WO 2016/033616 A1 describes binder jetted printed articles made from carbon powder. They are not actinically cured.

International Patent Application Publication No. WO 2016/089618 A1 describes describes binder jetted printed articles made from carbon powder. They are not actinically cured.

International Patent Application Publication No. WO 2018/196965 A1 discloses viscous liquid extrusion and fused deposition modeling, but does not include fiber reinforcement.

US Patent Application Publication No. 2020/0223757 A1 discloses binders to produce 3D printed green bodies. They are not actinically cured.

US Patent Application Publication No. 2020/0071487 A1 discloses composites with high temperature thermal conductivity. They do not include fiber and are not actinically cured.

US Patent Application Publication No. 2017/0001373 A1 discloses a method to deposit a mixture containing resin and additive powder using additive manufacturing. The resin is not actinically cured.

Non-patent literature publication Ceramics International, 2012, 38, 589-597 describes a photocurable resin but does not disclose a carbon bonded composite and carbon fiber reinforcement is not used.

Non-patent literature publication Additive Manufacturing, 2020, 34 101199 describes photocurable resin, but describes cure yield below 5%.

Compositions suitable for additive manufacturing systems that use actinic radiation to cure the compositions are challenging to produce and utilize, due to the opaque reinforcement in the composite composition. Accordingly, there remains a need for such compositions.

### SUMMARY

One aspect of the present invention provides a curable composition. The composition includes:
a) at least one aromatic, actinically curable component having an H/C_{atomic} ratio of from 0.4 to 1.6, selected from the group consisting of (meth)acrylate oligomers, epoxy-functionalized compounds, oxetane-functionalized compounds, and mixtures thereof;
b) at least one diluent comprising at least one actinically curable monomer;
c) an opaque reinforcement; and
d) a photoinitiator.

The curable composition may have a viscosity of at most 60,000 mPa·s at 25° C. The curable composition may create more than 18 weight % char after curing as measured by thermogravimetric analysis after 3 hour hold at 400° C., based on the weight of a), b) and d) after actinically curing. Importantly, the weight % char is based on the initial total weight of a), b) and d) in the actinically cured sample that is placed in the thermogravimetric analyzer. The actinically curable compositions may be used to coat any number of continuous reinforcements (e.g., separate fibers, tows, rovings, socks, and/or sheets of continuous material) to produce a reinforced composite.

According to an embodiment, the curable composition may include:
an (meth)acrylated epoxy novolak resin as a) the aromatic, actinically curable component;
at least one actinically curable monomer diluent selected from the group consisting of an ethoxylated bisphenol A diacrylate, 2-phenoxyethyl acrylate, tert-butylcyclohexyl acrylate, tricyclodecane dimethanol diacrylate, tris(2-hydroxy ethyl)isocyanurate triacrylate, mono- or polyoxyethylene p-cumylphenyl ether acrylate, trimethylolpropane triacrylate, and mixtures thereof; and
d) a phosphine oxide;
the curable composition further comprising at least one thermal initiator.

According to an embodiment, a) is a phenol-based acrylated epoxy novolak resin. According to further embodiments, a) is preferably a phenol/formaldehyde-based acrylated epoxy novolak resin. According to an embodiment, b) is preferably 35 wt % 2-phenoxyethyl acrylate and 10 wt % tris(2-hydroxy ethyl)isocyanurate triacrylate, by weight in the overall composition of a), and b).

### DETAILED DESCRIPTION

This invention is directed to actinic radiation-curable resin compositions for additive manufacturing of ablative composites for carbon bonded materials. The resin composition may be suitable for the pyrolysis/carbonization process necessary for conversion of a resin matrix/reinforcement ablative composite to a carbon bonded composite or carbon bonded ceramic. Such composites, especially carbon-carbon composites are particularly valuable in the energy and aerospace markets for tooling and structural materials in applications requiring high heatflux demands and ultra-high temperatures as high as 2000° C. or greater.

The compositions disclosed herein may include (meth)acrylated novolaks as oligomers derived from formaldehyde-phenol type novolaks. These are capable of curing with actinic (UV, in this case) radiation and provide for high carbon yield during pyrolysis. Actinic radiation is radiation capable of initiating a photochemical reaction. The compositions also include reactive diluent monomers that are also capable of curing with actinic radiation. These reactive diluent monomers maintain the viscosity of the curable compositions within ranges suitable for additive manufacturing processes. For example, it may be desirable for the curable compositions to have a viscosity of less than 60,000 mPa·s at 25° C.

These compositions are developed with the aim to achieve carbon yield (char) of preferably more than 18 weight % upon pyrolysis under an inert atmosphere and in temperature ranges between 400-1500° C. Such materials have sufficient mechanical properties to maintain their shape and resist shrinkage-related cracking/breaking during the pyrolysis/carbonization cycles.

Fabrication of these carbon-bonded composites and ceramics is currently not performed via an additive manufacturing process, also referred to as 3D printing. Traditional processes typically use a chopped rayon or carbon fiber weave infiltrated with either pitch or phenolic resins (such as novolaks) that include thermal crosslinkers, because they convert well to isotropic carbon in the pyrolysis/carbonization process.

The benefits of using additive manufacturing to manufacture these carbon bonded composites and ceramics are, for example, speed of manufacture, reduced cost/labor required, and greater freedom to fabricate composite parts of various unique and customized geometries. Due to the actinic radiation-opaque nature of the reinforcement, such as carbon fibers, required for this type of composite, these resin compositions are challenging to produce using actinic radiation. The term “opaque” as used herein in reference to the reinforcement should be understood to mean a reinforcement which blocks all or substantially all radiation across the UV and visible wavelengths.

Those skilled in the art will recognize that, depending upon such factors as physical form or method of synthesis, certain reinforcements may be either UV opaque or UV transparent. Mixtures of more than one reinforcement are within the scope of the invention, including embodiments of the invention having some opaque and some transparent reinforcements.

The present invention thus enables the production of articles containing opaque reinforcements, such that the composite materials are sufficiently cured to provide adequate green-strength for the subsequent pyrolysis, impregnation, and/or densification processes even though the reinforcement may block light from fully penetrating such depth or thickness. If the reinforcement is discontinuous (e.g., in the form of a plurality of particles or fibers that are separated from each other), there may be regions within the uncured actinically-curable composition in which portions of the light-curable resin component are completely shielded from light due to the presence of the reinforcement. Despite such shielding, sufficient curing of such regions is possible even if the light-curable composition is exposed to light from only one direction.

A curable composition is provided. The composition includes:
a) at least one aromatic, actinically curable component having an H/C_{atomic} ratio of from 0.4 to 1.6, selected from the group consisting of (meth)acrylate oligomers, epoxy-functionalized compounds, oxetane-functionalized compounds, and mixtures thereof;
b) at least one diluent comprising at least one actinically curable monomer;
c) an opaque reinforcement; and
d) a photoinitiator.

The curable composition may have a viscosity of at most 60,000 mPa·s at 25° C. For example, the curable composition may have a viscosity of at most 120,000 mPa·s, at most 100,000 mPa·s, at most 90,000 mPa·s, at most 80,000 mPa·s, at most 70,000 mPa·s, at most mPa·s, at most 60,000 mPa·s, at most 55,000 mPa·s, at most 50,000 mPa·s, at most 45,000 mPa·s, at most 40,000 mPa·s, at most 35,000 mPa·s, at most 30,000 mPa·s, at most mPa·s or at most 20,000 mPa·s at 25° C. as measured using a Brookfield viscometer, model DV-II, using a 27 spindle (with the spindle speed varying typically between 20 and 200 rpm, depending on viscosity).

The composition may create more than 18 weight % char after undergoing pyrolysis as measured by thermogravimetric analysis (TGA) after 3 hour hold at 400° C., based on the weight of a), b) and d) after actinically curing but prior to pyrolysis. Thus, it should be understood that, in some applications, the TGA apparatus serves to pyrolyze the actinically cured combination of a), b) and d), as well as to measure the weight % char, exclusive of reinforcement. For example, the composition may create more than 20 weight % or more than 22.5 weight %, or more than 25 weight %, or more than 30 weight % or more than 35 weight %, or more than 40 weight %, or more than 45 weight %, or more than 50 weight % char after curing as measured by thermogravimetric analysis after 3 hour hold at 400° C., based on the weight of a), b) and d) after actinically curing. The reinforcement is not included in the amount of char. The weight % char after pyrolysis in the TGA instrument therefore is based on the total weight of the cured composition excluding the amount of reinforcement c), prior pyrolysis in the TGA apparatus.

The measurement of the weight % char is carried out as follows. The weight % char of a small amount of actinically cured material (10-30 mg of resin without reinforcement) may be measured (e.g., using a TA Instruments Q50 TGA). The following heating procedure may then be used for pyrolysis: ramp from room temperature to 300° C. at a ramp rate of 5° C./min, ramp from 300° C. to 400° C. at 1° C./min, hold at 400° C. for 3 hours, ramp from 400° C. to 500° C. at 1° C./min, hold at 500° C. for 3 hours, and finally ramp from 500° C. to 1000° C. after which the pyrolysis is ended. A continuous flow of 40-60 mL/min of nitrogen was used as an inert purge gas throughout the heating procedure. The weight % char at a given temperature can be determined as the percentage of residual material weight divided by the weight of the actinically cured sample recorded at the start of the pyrolysis. Preferably, the weight % char value reported is taken as the weight % remaining at the end of either the 3 hour holding period at 400° C.

The pyrolysis process may be done by exposing the cured composition to elevated temperatures (for example, temperatures of about 400-500° C. or up to 3000° C.) that causes the cured composition to pyrolyze. In some cases, the pyrolysis may be enhanced when performed within a controlled environment (e.g., in an atmosphere containing negligible amounts of oxygen). Thus, the pyrolysis may be done in inert atmosphere such as under an inert gas such as nitrogen, argon or helium.

Regarding the weight % char, it should be understood that it represents the amount of char that is present after the first pyrolysis of the cured composition (i.e., not including the weight of the reinforcement) that will be made into a carbon-bonded-carbon composite or carbon-bonded ceramic composite. As described above, the complete process involves subsequent repeated cycles of impregnation of char-forming materials and then pyrolysis to build a carbon matrix of the carbon-bonded composite or ceramic. The radiation curable composition disclosed herein is particularly suited to form the initial ablative composite part in its final or nearly final shape (the green composite) via 3D printing while simultaneously contributing a significant portion of the final carbon matrix. Thus, this curable composition enables a cost-effective and time-saving initial fabrication step, while also reducing the need for further impregnation and pyrolysis steps, which contributes to the overall process efficiency above and beyond the efficiency gained by reducing or minimizing the post-process machining needed to form the final part.

In some embodiments, Hydrogen/Carbon atomic ratios (H/C_{atomic} ratio) and Aromatic Content (AC) are key structural descriptors for establishing a structure-property relationship between the resin feedstocks in the curable composition and their ability to serve as sacrificial materials for high yield carbonization in ablative composites, i.e., carbon-bonded composites where the carbon matrix is formed by pyrolysis of a sacrificial matrix material surrounding the opaque reinforcement. Without wishing to be bound by any theory, carbonization due to pyrolysis may include polymerization and growth, that results in desirable carbon enrichment of the carbon matrix. Since the high temperature of the pyrolysis process necessarily drives off volatiles, the carbon left behind has porosity. A certain amount and morphology of this porosity is desirable but too much porosity is not desirable since it leads to structural problems.

The H/C_{atomic} ratio herein is defined as the number of hydrogen atoms in a given molecule divided by the number of carbons atoms in the same molecule. The H/C_{atomic} ratio does not consider heteroatoms (e.g., O, S, N, P) in a molecule. The H/C_{atomic} ratio, for the purposes of this disclosure, may be used to evaluate unreacted actinically-curable components, monomers, and additives. Lower values of H/C_{atomic} ratio are more ideal and H/C_{atomic} ratio theoretically trends close to 0 for graphite. Thus, it may be understood that H/C_{atomic} ratio may be related to the aromaticity of the composition.

The H/C_{atomic} ratio of a mixture of compounds corresponds to the weight average H/C_{atomic} ratio of the mixture. For a mixture comprising a number n of compounds, the weight average H/C_{atomic} ratio of the mixture may be calculated with the following equation:

$$H / {C}_{atomic} ratio = {\sum }_{i = 1}^{n} {w}_{i} \times H / {C}_{i}$$

wherein wᵢ is the mass fraction of compound i in the mixture (mass of compound i divided by the total mass of the mixture);
H/Cᵢ is the H/C_{atomic} ratio of compound i.

The Aromatic Content (AC) value is used to describe unreacted actinically-curable components, monomers, and additives. The AC, for purposes of this disclosure, may be understood to be the average number of aromatic rings per molecule. Aromatic in the traditional sense is defined by IUPAC as having a chemistry typified by benzene. AC as used in this disclosure is meant as an actinically cured monomer, component or additive containing a single or multiple benzene rings in any configuration (e.g., monocyclics, fused rings, polycyclics, bridged), and any single or combination of substitutions (ortho, meta, para, etc.). This invention does not limit benzene ring content to other benzene rings, but additionally includes configurations of benzene rings with fused with heterocycles, carbocyclics, epoxy rings, and oxetane rings within a single actinically-curable monomer, component or additive. For example, a benzene ring fused with another ring would be included in this definition. For example, 7-hydroxycoumarin functionalized with as an acrylic group would fall within the present definition of an aromatic species useful in the present invention.

The Aromatic Content (AC) value of a mixture of compounds corresponds to the weight average AC value of the mixture. For a mixture comprising a number n of compounds, the weight average AC value of the mixture may be calculated with the following equation:

$$A C = {\sum }_{i = 1}^{n} {w}_{i} \times A {C}_{i}$$

wherein wᵢ is the mass fraction of compound i in the mixture (mass of compound i divided by the total mass of the mixture); ACᵢ is the AC value of compound i.

As used herein, (meth)acrylated substances may be referred to as “monomers”, i.e., component b) if they may be formed by reaction of a hydroxyl group with (meth)acrylic acid (or ester) in a condensation reaction. (Meth)acrylated substances may be referred to as “oligomers”, i.e., they may be in component a), if they may be formed by addition reactions to epoxy compounds, isocyanates, etc. Accordingly, polyethylene glycol diacrylate and ethoxylated bisphenol A diacrylate would be monomers even though they have ethylene oxide repeating units whereas bisphenol A diglycidyl ether diacrylate is an “oligomer” even though it has no repeating units.

In embodiments of the curable composition, the combination of a) the at least one aromatic, actinically curable component selected from the group consisting of (meth)acrylate oligomers, epoxy-functionalized compounds, oxetane-functionalized compounds, and mixtures thereof, and b) the at least one actinically curable monomer may have an H/C_{atomic} ratio of from 0.4 to 1.6. For example the H/C_{atomic} ratio of a) and b) together in the curable composition (i.e., the net H/C_{atomic} ratio of a) and b)) may be from 0.5 to 1.5, from 0.6 to 1.3, from 0.7 to 1.4, from 0.8 to 1.3, from 0.9 to 1.2, from 1.0 to 1.1. According to a preferred embodiment, the a) at least one aromatic, actinically curable component selected from the group consisting of (meth)acrylate oligomers, epoxy-functionalized compounds, oxetane-functionalized compounds, and mixtures thereof, and the b) at least one actinically curable monomer may each have an H/C_{atomic} ratio of from 0.4 to 1.6. For example, the H/C_{atomic} ratio of a) may be from 0.5 to 1.5, from 0.6 to 1.3, from 0.7 to 1.4, from 0.8 to 1.3, from 0.9 to 1.2, from 1.0 to 1.1; and in addition the H/C_{atomic} ratio of b) may be from 0.5 to 1.5, from 0.6 to 1.3, from 0.7 to 1.4, from 0.8 to 1.3, from 0.9 to 1.2, from 1.0 to 1.1.

According to an embodiment, the curable composition may include:
a (meth)acrylated epoxy novolak resin as a) the aromatic, actinically curable component; and
at least one actinically curable monomer diluent as b), which may be selected from the group consisting of an ethoxylated bisphenol A diacrylate (in particular ethoxylated3 bisphenol A diacrylate), 2-phenoxyethyl acrylate, tert-butylcyclohexyl acrylate, tricyclodecane dimethanol diacrylate, tris(2-hydroxy ethyl)isocyanurate triacrylate, mono- or polyoxyethylene p-cumylphenyl ether acrylate, trimethylolpropane triacrylate, and mixtures thereof; and
a phosphine oxide, in particular phenylbis(2,4,6-trimethylbenzolyl)phosphine oxide as photo initiator d).

According to an embodiment, a) is a (meth)acrylated phenol-based epoxy novolak. According to further embodiments, a) is preferably a phenol/formaldehyde-based acrylated epoxy novolak resin. According to an embodiment, b) is preferably 35 wt % 2-phenoxyethyl acrylate and 10 wt % tris(2-hydroxy ethyl)isocyanurate triacrylate, by weight in the overall composition of a) and b). According to an embodiment, c) may be continuous fibers.

a) Aromatic, Actinically Curable Component:

Component a) comprises, consists of or consists essentially of at least one aromatic actinically curable component. Component a) may comprise, consist of or consist essentially of a mixture of aromatic actinically curable components.

Component a) comprises, consists of or consists essentially of at least one aromatic actinically curable component selected from the group consisting of (meth)acrylate oligomers, epoxy-functionalized compounds, oxetane-functionalized compounds, and mixtures thereof.

Component a) may comprise, consist of or consist essentially of at least one aromatic actinically curable component comprising at least one (meth)acrylate group, in particular at least two (meth)acrylate groups. Component a) may comprise, consist of or consist essentially of at least one aromatic actinically curable component comprising at least one acrylate group, in particular at least two acrylate groups. Component a) may comprise, consist of or consist essentially of at least one aromatic (meth)acrylate oligomer comprising at least two (meth)acrylate groups, in particular more than two (meth)acrylate groups. Component a) may comprise, consist of or consist essentially of at least one aromatic (meth)acrylate oligomer comprising at least two acrylate groups, in particular more than two acrylate groups.

Component a) may comprise, consist of or consist essentially of at least one (meth)acrylated aromatic epoxy resin. As used herein, the term “(meth)acrylated aromatic epoxy resin” means the reaction product of at least one aromatic epoxy resin and (meth)acrylic acid. As used herein, the term “aromatic epoxy resin” means an aromatic compound comprising at least one epoxy group, in particular at least two epoxy groups, more particularly more than two epoxy groups. Component a) may comprise, consist of or consist essentially of at least one (meth)acrylated aromatic glycidyl ether resin. As used herein, the term “(meth)acrylated aromatic glycidyl ether resin” means the reaction product of at least one aromatic glycidyl ether resin and (meth)acrylic acid. As used herein, the term “aromatic glycidyl ether resin” means an aromatic compound comprising at least one glycidyl ether group, in particular at least two glycidyl ether groups. As used herein, the term “glycidyl ether group” means a group of the following formula (I):

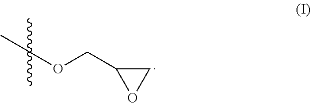 [SMILES: *OCC1CO1]

Component a) may comprise, consist of or consist essentially of at least one (meth)acrylated aromatic glycidyl ether resin selected from a (meth)acrylated epoxy novolak resin, a (meth)acrylated bisphenol-based diglycidyl ether and mixtures thereof.

In one embodiment, component a) may comprise, consist of or consist essentially of at least one (meth)acrylated epoxy novolak resin. The (meth)acrylated epoxy novolak resin may have an average number of (meth)acrylate groups of 1 to 15, in particular 2 to 10. The epoxy novolak resin used to obtain the (meth)acrylated epoxy novolak resin may be a phenol-based epoxy novolak resin, a bisphenol-based epoxy novolak resin or a cresol-based epoxy novolak resin, more particularly a phenol-based epoxy novolak resin.

An epoxy novolak resin may be represented by the following formula (II):

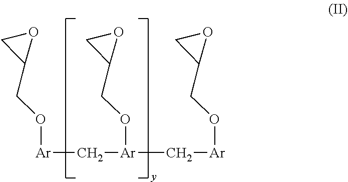

wherein
Ar is an aromatic linker, in particular phenylene, tolylene or an optionally substituted diphenylmethane radical;
y is 0 to 50.

In one embodiment, component a) may comprise, consist of or consist essentially of at least one (meth)acrylated bisphenol-based diglycidyl ether. The bisphenol-based diglycidyl ether used to obtain the (meth)acrylated bisphenol-based diglycidyl ether may be represented by the following formula (III):

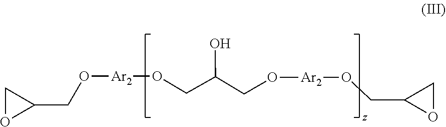

wherein
Ar₂ is a linker of formula (IV)

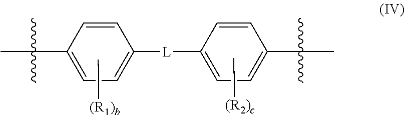

wherein L is a linker;
R₁ and R₂ are independently selected from alkyl, cycloalkyl, aryl and a halogen atom;
b and c are independently 0 to 4; and
z is 0 to 50.

In particular, L may be a linker selected from bond, —CR₃R₄—, —C(═O)—, —SO—, —SO₂—, —C(═CCl₂)— and —CR₅R₆-Ph-CR₇R₈—;
wherein:
R₃ and R₄ are independently selected from H, alkyl, cycloalkyl, aryl, haloalkyl and perfluoroalkyl, or R₃ and R₄, with the carbon atoms to which they are attached, may form a ring;
R₅, R₆, R₇ and R₅ are independently selected from H, alkyl, cycloalkyl, aryl, haloalkyl and perfluoroalkyl;
Ph is phenylene optionally substituted with one or more groups selected from alkyl, cycloalkyl, aryl and a halogen atom.

More particularly, Ar₂ may be the residue of a bisphenol without the OH groups. A compound according to formula (III) wherein Ar₂ is the residue of a bisphenol without the OH groups may be referred to as a bisphenol-based diepoxy ether, preferably a bisphenol-based diglycidyl ether. Examples of suitable bisphenols are bisphenol A, bisphenol AP, bisphenol AF, bisphenol B, bisphenol BP, bisphenol C, bisphenol C2, bisphenol F, bisphenol G, bisphenol M, bisphenol S, bisphenol P, bisphenol PH, bisphenol TMC, bisphenol-Z, dinitrobisphenol A, tetrabromobisphenol A and combinations thereof.

Since it is desirable to maximize the amount of carbon present in the form of char in the carbon bonded composite after the pyrolysis step, the ratio of hydrogen atoms to carbon atoms (H/C_{atomic} ratio) in the aromatic actinically curable component is preferably from about to 1.6. For example, the H/C_{atomic} ratio of the aromatic actinically curable component may be from 0.7 to 1.4. Component a) comprises at least one aromatic, actinically curable component having an H/C_{atomic} ratio of from 0.4 to 1.6, from 0.5 to 1.5, from 0.6 to 1.4, from to 1.4, from 0.8 to 1.3, from 0.9 to 1.2 or from 1.0 to 1.1. If component a) comprises a mixture of aromatic actinically curable components, the weight average H/C_{atomic} ratio of component a) may be from 0.4 to 1.6, from 0.5 to 1.5, from 0.6 to 1.4, from 0.7 to 1.4, from to 1.3, from 0.9 to 1.2 or from 1.0 to 1.1.

The aromatic, actinically curable component may have an aromatic content (AC) of at least 1. For example, the AC value of the aromatic, actinically curable component may be at least 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 65.5, 6, 6.5, 7, 7.5, 8, 8.5, 9, 9.5, or at least 10 aromatic rings per molecule on average. Component a) may comprise at least one aromatic, actinically curable component having an AC value of at least 1, at least 2, at least 3, at least 4, at least 5, at least 6, at least 7, at least 8, at least 9 or at least 10. If component a) comprises a mixture of aromatic actinically curable components, the weight average AC value of component a) may be at least 1, at least 2, at least 3, at least 4, at least 5, at least 6, at least 7, at least 8, at least 9 or at least 10.

The a) aromatic, actinically curable component may include at least one phenolic moiety, i.e. an oxygen directly bonded to at least one aromatic ring. For example, the phenolic moiety may include a backbone of phenol formaldehyde resin with a formaldehyde:phenol molar ratio of less than 1. A novolak resin modified with at least one (meth)acrylate group is a non-limiting example of such a structure that contains phenolic moieties. As used herein, “novolak” resins modified with at least one (meth)acrylate group may be based on hydroxyl aromatic structures such as, but not limited to, phenolics, bisphenol-based, bisphenol A-based, or cresol-based, for example.

According to an embodiment, the a) aromatic actinically curable component is preferably a (meth)acrylated phenol-based epoxy novolak resin. According to further embodiments, a) is preferably an acrylated phenol/formaldehyde-based epoxy novolak resin.

According to embodiments, a) may be present in the actinically curable composition at 5 to 95 wt %, based on the total weight of a) and b) in the composition. For example, the a) aromatic actinically curable component may be present at from 10-90 wt %, from 15-85 wt %, from 20-80 wt %, from 25-75 wt %, from 30-70 wt %, from 35-65 wt %, from 40-60 wt % based on the total weight of a) and b) in the composition.

The a) aromatic, actinically curable component may include at least one (meth)acrylate group per molecule. As used herein the term, “(meth)acrylate” in understood to encompass either or both methacrylate group and acrylate group. As is known in the art, (meth)acrylate groups are capable of curing with actinic radiation in the presence of a free-radical generating photo-initiator. The a) aromatic, actinically curable component may preferably include at least one acrylate group per molecule. The a) aromatic, actinically curable component may include at least two (meth)acrylate groups per molecule. The a) aromatic, actinically curable component may preferably include at least two acrylate groups per molecule.

Epoxy groups and/or oxetane groups are also contemplated as the actinically curable group on the a) aromatic, actinically curable component. For example, the a) aromatic, actinically curable component may include at least one epoxy group and/or at least one oxetane group per molecule. Such groups may be capable of curing with actinic radiation in the presence of a cation-generating photo-initiator. Component a) may comprise, consist of or consist essentially of at least one aromatic, actinically curable component comprising at least one epoxy group and/or at least one oxetane group per molecule. The a) aromatic, actinically curable component may include at least one epoxy group and/or at least one oxetane group per molecule and at least one (meth)acrylate group per molecule. Component a) may comprise, consist of or consist essentially of at least one aromatic, actinically curable component comprising at least one epoxy group and/or at least one oxetane group per molecule and further comprising at least one (meth)acrylate group per molecule. The a) aromatic, actinically curable component may include a first compound containing at least one epoxy group and/or at least one oxetane group per molecule and a second compound containing at least one (meth)acrylate group per molecule. Component a) may comprise, consist of or consist essentially of a first aromatic, actinically curable component comprising at least one epoxy group and/or at least one oxetane group per molecule and a second aromatic, actinically curable component comprising at least one (meth)acrylate group per molecule.

The a) aromatic, actinically curable component may further include other ethylenically unsaturated functional groups that are capable of curing with actinic radiation. Non-limiting examples, such as vinylics, styrenics, or malonates, in addition to or as alternatives to (meth)acrylate groups are contemplated according to some embodiments of the disclosure.

Non-limiting particular examples of suitable aromatic actinically curable (meth)acrylate oligomers are: (meth)acrylated novolak oligomers, such as the following structure:

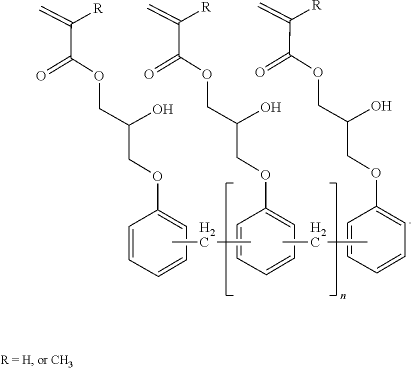

The (meth)acrylated novolak oligomer may have an average number of (meth)acrylate groups of 1 to 15, in particular 2 to 10.

Other non-limiting examples of suitable a) actinically curable component include (meth)acrylate oligomers such as (meth)acrylate esters of lignin, pitch, lignite, tar, creosote, as well as mixtures of any or all of these.

Non-limiting examples of epoxy (meth)acrylate oligomers suitable for component a) include the reaction products of acrylic or methacrylic acid or mixtures thereof with an epoxy resin (glycidyl ether or ester). The epoxy (meth)acrylates may, in particular, be selected from the reaction products of acrylic or methacrylic acid or mixtures thereof with bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resin, and mixtures thereof.

Epoxy-functionalized compounds (i.e., cationically initiated polymerizable compounds) suitable for use as aromatic, actinically curable component a) include but are not limited to bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether and mixtures thereof.

Oxetane-functionalized compounds (i.e., cationically initiated polymerizable compounds) suitable for use as aromatic, actinically curable component a) include but are not limited to 1,4-Bis[(3-ethyl-3-oxetanylmethoxy)methyl]benzene, 4,4′-Bis(3-ethyl-3-oxetanyl)methoxymethyl]biphenyl and mixtures thereof.

b) Diluent Including Actinically Curable Monomer:

Component b) comprises, consists of or consists essentially of at least one actinically curable monomer. Component b) may comprise a mixture of actinically curable monomers. Component b) is distinct from component a).

Component b) may comprise, consist of or consist essentially of at least one actinically curable monomer comprising at least one (meth)acrylate group per molecule. Component b) may comprise, consist of or consist essentially of at least one actinically curable monomer comprising at least one acrylate group per molecule. Component b) may comprise, consist of or consist essentially of at least one actinically curable monomer comprising at least two (meth)acrylate group per molecule. Component b) may comprise, consist of or consist essentially of at least one actinically curable monomer comprising at least two acrylate group per molecule. Component b) may comprise, consist of or consist essentially of at least one actinically curable monomer comprising 3, 4, 5, or 6 (meth)acrylate groups per molecule.

The b) diluent including at least one actinically curable monomer may include at least one (meth)acrylate group per molecule. As used herein the term, “(meth)acrylate” is understood to encompass either or both methacrylate group and acrylate group. As is known in the art, (meth)acrylate groups are capable of curing with actinic radiation in the presence of a free-radical generating photo-initiator. The b) diluent including at least one actinically curable monomer may preferably include at least one acrylate group per molecule. The b) diluent including at least one actinically curable monomer may include at least two (meth)acrylate groups per molecule. The b) diluent including at least one actinically curable monomer may preferably include at least two acrylate groups per molecule. The b) diluent actinically curable monomer may be aromatic. The b) diluent may include 3, 4, 5, or 6 (meth)acrylate groups per molecule.

Since it is desirable to maximize the amount of carbon present in the form of char in the carbon bonded composite after the pyrolysis step, the ratio of hydrogen atoms to carbon atoms (H/C_{atomic} ratio) in the b) actinically curable monomer may be from about 0.4 to 1.6. For example, the H/C_{atomic} ratio of the b) actinically curable monomer diluent may be from 0.7 to 1.4. For example the H/C_{atomic} ratio of b) actinically curable monomer may be from 0.5 to 1.5, from 0.6 to 1.3, from 0.7 to 1.4, from 0.8 to 1.3, from 0.9 to 1.2, from 1.0 to 1.1. Component b) may comprise at least one actinically curable monomer having an H/C_{atomic} ratio of from 0.4 to 1.6, from 0.5 to 1.5, from 0.6 to 1.4, from 0.7 to 1.4, from 0.8 to 1.3, from 0.9 to 1.2 or from 1.0 to 1.1. If component b) comprises a mixture of actinically curable monomers, the weight average H/C_{atomic} ratio of component b) may be from 0.4 to 1.6, from 0.5 to 1.5, from 0.6 to 1.4, from 0.7 to 1.4, from 0.8 to 1.3, from 0.9 to 1.2 or from 1.0 to 1.1.

The b) actinically curable monomer may have an aromatic content (AC) of at least 1. For example, the AC value of the b) actinically curable monomer may be at least 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 65.5, 6, 6.5, 7, 7.5, 8, 8.5, 9, 9.5, or at least 10 aromatic rings per molecule on average. Component b) may comprise at least one actinically curable monomer having an AC value of at least 1 or at least 2. If component b) comprises a mixture of actinically curable monomers, the weight average AC value of component b) may be at least 0.30, at least 0.35, at least 0.40, at least 0.45, at least 0.50, at least 0.55, at least 0.60, at least 0.65, at least 0.70, at least 0.75, at least 0.80, at least 0.85, at least 0.90, at least 1.0, at least 1.1, at least 1.2, at least 1.3, at least 1.4, at least 1.5, at least 1.6, at least 1.7, at least 1.8, at least 1.9 or at least 2.0.

According to an embodiment, component b) may comprise, consist of or consist essentially of at least one actinically curable monomer selected from the group consisting of an ethoxylated bisphenol A diacrylate, 2-phenoxyethyl acrylate, tert-butylcyclohexyl acrylate, tricyclodecane dimethanol diacrylate, tris(2-hydroxy ethyl)isocyanurate triacrylate, mono- or polyoxyethylene p-cumylphenyl ether acrylate, trimethylolpropane triacrylate, and mixtures thereof.

According to an embodiment, the b) at least one actinically curable monomer diluent may be selected from the group consisting of an ethoxylated bisphenol A diacrylate (in particular ethoxylated3 bisphenol A diacrylate), 2-phenoxyethyl acrylate, tert-butylcyclohexyl acrylate, tricyclodecane dimethanol diacrylate, tris(2-hydroxy ethyl)isocyanurate triacrylate, mono- or polyoxyethylene p-cumylphenyl ether acrylate, trimethylolpropane triacrylate, and mixtures thereof.

Component b) may be present in the actinically curable composition at 5 to 95 wt %, based on the total weight of a) and b) in the composition. For example, the b) actinically curable monomer diluent may be present at from 10-90 wt %, from 15-85 wt %, from 20-80 wt %, from 25-75 wt %, from 30-70 wt %, from 35-65 wt %, from 40-60 wt %, based on the total weight of a) and b) in the composition.

Component b) may comprise, consist of or consist essentially at least one aromatic actinically curable monomer. Preferably, component b) comprises, consists of or consists essentially at least one aromatic actinically curable monomer and optionally one or more non-aromatic actinically curable monomers. The at least one aromatic actinically curable monomer may be selected from the group consisting of an ethoxylated bisphenol A diacrylate, 2-phenoxyethyl acrylate, mono- or polyoxyethylene p-cumylphenyl ether acrylate, and mixtures thereof. The optional non-aromatic actinically curable monomer may be a cyclic monomer, i.e a monomer bearing at least one non-aromatic ring. The optional non-aromatic actinically curable monomer may be selected from the group consisting of tert-butylcyclohexyl acrylate, tricyclodecane dimethanol diacrylate, tris(2-hydroxy ethyl)isocyanurate triacrylate, and mixtures thereof. In particular, the total weight of aromatic actinically curable monomer in component b) may be from 20 to 100%, from 25 to 95%, from 30 to 90%, from 35 to 85%, from 40 to 80%, from 45 to 75%, from 50 to 70%, based on the total weight of component b). More particularly, the total weight of non-aromatic actinically curable monomer in component b) may be from 0 to 80%, from 5 to 75%, from 10 to 70%, from 15 to 65%, from 20 to 60%, from 25 to 55%, from 30 to 50%, based on the total weight of the b).

According to an embodiment, b) may be preferably 35 wt % 2-phenoxyethyl acrylate and 10 wt % tris(2-hydroxy ethyl)isocyanurate triacrylate, by weight in the overall composition of a), and b). For example b) may preferably be from 10-60 wt %, 15-55 wt %, 20-50 wt %, 25-45 wt %, or 30-40 wt % 2-phenoxyethyl acrylate and from 1-20, 1-19, 3-18, 4-17, 5-16, 6-15, 7-14, 8-13, 9-12, or 9 to 11 wt % tris(2-hydroxy ethyl)isocyanurate triacrylate, by weight in the overall composition of a), and b).

Epoxy groups and/or oxetane groups are also contemplated as the actinically curable group on the b) actinically curable monomer. For example, the b) diluent including at least one actinically curable monomer may include at least one epoxy group and/or oxetane group per molecule. Such groups are capable of curing with actinic radiation in the presence of a cation-generating photo-initiator. Component b) may comprise, consist of or consist essentially of at least one actinically curable monomer comprising at least one epoxy group and/or at least one oxetane group per molecule. The b) diluent including at least one actinically curable monomer may include at least one epoxy group and/or at least one oxetane group per molecule and at least one (meth)acrylate group per molecule. Component b) may comprise, consist of or consist essentially of at least one actinically curable monomer comprising at least one epoxy group and/or at least one oxetane group per molecule and further comprising at least one (meth)acrylate group per molecule. The b) diluent including at least one actinically curable monomer may include a first compound containing at least one epoxy group and/or at least one oxetane group per molecule and a second compound containing at least one (meth)acrylate group per molecule. Component b) may comprise, consist of or consist essentially of a first actinically curable monomer comprising at least one epoxy group and/or at least one oxetane group per molecule and a second actinically curable monomer comprising at least one (meth)acrylate group per molecule.

The b) diluent including at least one actinically curable monomer may further include other ethylenically unsaturated functional groups that are capable of curing with actinic radiation. Non-limiting examples, such as vinylics, styrenics, or malonates, in addition to or as alternatives to (meth)acrylate groups are contemplated according to some embodiments of the disclosure. The b) diluent actinically curable monomer may further include other ethylenically unsaturated functional groups, such as vinylics, vinyl aromatics, styrenics, malonates, in addition to or as alternatives to (meth)acrylate groups.

Non-limiting particular examples of suitable b) diluent including at least one actinically curable monomer are: trimethylolpropane triacrylate, tricyclodecane dimethanol diacrylate, tris(2-hydroxyethyl) isocyanurate triacrylate, mono- or polyoxyethylene p-cumylphenyl ether acrylate, an ethoxylated bisphenol A diacrylate (in particular ethoxylated3 bisphenol A diacrylate), 2-phenoxyethyl acrylate, 4-tert-butylcyclohexyl acrylate, fluorine acrylates, 9,9 bisphenyl fluorine acrylates, 9,9-bisphenylglycidyl diacrylate, 9,9-bispheno di(meth)acrylate, anthracene (meth)acrylates, cumyl (meth)acrylates, p-cumylphenyl (meth)acrylate, phenyl (meth)acrylates, benzyl (meth)acrylates, phenyl (meth)acrylate, benzyl (meth)acrylate, acrylated bis-phenol (meth)acrylates, coumarin (meth)acrylates, salicylate(meth)acrylates, homosalate(meth)acrylate, phthalic anhydride(meth) acrylates, (meth)acrylate resorcinols, and mixtures thereof.

Representative, but not limiting, examples of suitable monomeric (meth)acrylate-functionalized compounds for component b) include: 1,3-butylene glycol di(meth)acrylate, 1,4-butanediol di(meth)acrylate, 1,6-hexanediol di(meth)acrylate, longer chain aliphatic di(meth)acrylates (such as those generally corresponding to the formula H₂C═CRC(═O)—O—(CH₂)ₘ—O—C(═O)CR′═CH₂, wherein R and R′ are independently H or methyl and m is an integer of 8 to 24), alkoxylated (e.g., ethoxylated, propoxylated) hexanediol di(meth)acrylates, alkoxylated (e.g., ethoxylated, propoxylated) neopentyl glycol di(meth)acrylates, dodecyl di(meth) acrylates, cyclohexane dimethanol di(meth)acrylates, diethylene glycol di(meth)acrylates, dipropylene glycol di(meth)acrylates, alkoxylated (e.g., ethoxylated, propoxylated) bisphenol A di(meth)acrylates, ethylene glycol di(meth)acrylates, neopentyl glycol di(meth)acrylates, tricyclodecane dimethanol diacrylates, triethylene glycol di(meth)acrylates, tetraethylene glycol di(meth)acrylates, tripropylene glycol di(meth)acrylates, ditrimethylolpropane tetra(meth)acrylates, dipentaerythritol penta(meth)acrylates, alkoxylated (e.g., ethoxylated, propoxylated) pentaerythritol tetra(meth)acrylate, dipentaerythritol penta(meth)acrylates, pentaerythritol tetra(meth)acrylate, alkoxylated (e.g., ethoxylated, propoxylated) trimethylolpropane tri(meth)acrylates, alkoxylated (e.g., ethoxylated, propoxylated) glyceryl tri(meth)acrylates, trimethylolpropane tri(meth)acrylates, pentaerythritol tri(meth)acrylates, tris (2-hydroxy ethyl) isocyanurate tri(meth)acrylates, 2(2-ethoxyethoxy) ethyl (meth)acrylates, 2-phenoxyethyl (meth)acrylates, 3,3,5-trimethylcyclohexyl (meth)acrylates, alkoxylated lauryl (meth)acrylates, alkoxylated phenol (meth)acrylates, alkoxylated tetrahydrofurfuryl (meth)acrylates, caprolactone (meth)acrylates, cyclic trimethylolpropane formal (meth)acrylates, dicyclopentadienyl (meth)acrylates, diethylene glycol methyl ether (meth)acrylates, alkoxylated (e.g., ethoxylated, propoxylated) nonyl phenol (meth)acrylates, isobornyl (meth)acrylates, isodecyl (meth)acrylates, isooctyl (meth)acrylates, lauryl (meth)acrylates, methoxy polyethylene glycol (meth)acrylates, octyldecyl (meth)acrylates (also known as stearyl (meth)acrylates), tetrahydrofurfuryl (meth) acrylates, tridecyl (meth)acrylates, triethylene glycol ethyl ether (meth)acrylates, t-butyl cyclohexyl (meth)acrylates, dicyclopentadiene di(meth)acrylates, phenoxyethanol (meth)acrylates, octyl (meth)acrylates, decyl (meth)acrylates, dodecyl (meth)acrylates, tetradecyl (meth)acrylates, cetyl (meth)acrylates, hexadecyl (meth)acrylates, behenyl (meth)acrylates, diethylene glycol ethyl ether (meth)acrylates, diethylene glycol butyl ether (meth)acrylates, triethylene glycol methyl ether (meth)acrylates, dodecanediol di (meth)acrylates, dipentaerythritol penta/hexa(meth)acrylates, pentaerythritol tetra(meth)acrylates, alkoxylated (e.g., ethoxylated, propoxylated) pentaerythritol tetra(meth)acrylates, di-trimethylolpropane tetra(meth)acrylates, alkoxylated (e.g., ethoxylated, propoxylated) glyceryl tri(meth)acrylates, and tris (2-hydroxy ethyl) isocyanurate tri(meth)acrylates, (meth)acrylates of resorcinols, (meth)acrylates of phenol, (meth)acrylates of guauacols, (meth)acrylates of xylenols, (meth)acrylates of creosols, and combinations thereof.

The following compounds are specific examples of mono(meth)acrylate-functionalized monomers suitable for use in the curable compositions of the present invention: methyl (meth)acrylate; ethyl (meth)acrylate; n-propyl (meth)acrylate; n-butyl (meth)acrylate; isobutyl (meth)acrylate; n-hexyl (meth)acrylate; 2-ethylhexyl (meth)acrylate; n-octyl (meth)acrylate; isooctyl (meth)acrylate; n-decyl (meth)acrylate; n-dodecyl (meth)acrylate; tridecyl (meth)acrylate; tetradecyl (meth)acrylate; hexadecyl (meth)acrylate; 2-hydroxyethyl (meth)acrylate; 2- and 3-hydroxypropyl (meth)acrylate; 2-methoxyethyl (meth)acrylate; 2-ethoxyethyl (meth)acrylate; 2- and 3-ethoxypropyl (meth)acrylate; tetrahydrofurfuryl (meth)acrylate; alkoxylated tetrahydrofurfuryl (meth)acrylate; 2-(2-ethoxyethoxy)ethyl (meth)acrylate; cyclohexyl (meth)acrylate; glycidyl (meth)acrylate; isodecyl (meth)acrylate; lauryl (meth)acrylate; alkoxylated phenol (meth)acrylates; alkoxylated nonylphenol (meth)acrylates; cyclic trimethylolpropane formal (meth)acrylate; isobornyl (meth)acrylate; tricyclodecanemethanol (meth)acrylate; tert-butylcyclohexanol (meth)acrylate; trimethylcyclohexanol (meth)acrylate; diethylene glycol monomethyl ether (meth)acrylate; diethylene glycol monoethyl ether (meth)acrylate; diethylene glycol monobutyl ether (meth)acrylate; triethylene glycol monoethyl ether (meth)acrylate; ethoxylated lauryl (meth)acrylate; methoxy polyethylene glycol (meth)acrylates; hydroxyl ethyl-butyl urethane (meth)acrylates; 3-(2-hydroxyalkyl)oxazolidinone (meth)acrylates; and combinations thereof.

Exemplary (meth)acrylate-functionalized monomers containing two or more (meth)acrylate groups per molecule may include ethoxylated bisphenol A di(meth)acrylates; triethylene glycol di(meth)acrylate; ethylene glycol di(meth)acrylate; tetraethylene glycol di(meth)acrylate; polyethylene glycol di(meth)acrylates; 1,4-butanediol diacrylate; 1,4-butanediol dimethacrylate; diethylene glycol diacrylate; diethylene glycol dimethacrylate, 1,6-hexanediol diacrylate; 1,6-hexanediol dimethacrylate; neopentyl glycol diacrylate; neopentyl glycol di(meth)acrylate; polyethylene glycol (600) dimethacrylate (where 600 refers to the approximate number average molecular weight of the polyethylene glycol portion); polyethylene glycol (200) diacrylate; 1,12-dodecanediol dimethacrylate; tetraethylene glycol diacrylate; triethylene glycol diacrylate, 1,3-butylene glycol dimethacrylate, tripropylene glycol diacrylate, polybutadiene diacrylate; methyl pentanediol diacrylate; polyethylene glycol (400) diacrylate; ethoxylated2 bisphenol A dimethacrylate; ethoxylated3 bisphenol A dimethacrylate; ethoxylated3 bisphenol A diacrylate; cyclohexane dimethanol dimethacrylate; cyclohexane dimethanol diacrylate; ethoxylated10 bisphenol A dimethacrylate (where the numeral following “ethoxylated” is the average number of oxyalkylene moieties per molecule); dipropylene glycol diacrylate; ethoxylated4 bisphenol A dimethacrylate; ethoxylated6 bisphenol A dimethacrylate; ethoxylated8 bisphenol A dimethacrylate; alkoxylated hexanediol diacrylates; alkoxylated cyclohexane dimethanol diacrylate; dodecane diacrylate; ethoxylated4 bisphenol A diacrylate; ethoxylated10 bisphenol A diacrylate; polyethylene glycol (400) dimethacrylate; polypropylene glycol (400) dimethacrylate; metallic diacrylates; modified metallic diacrylates; metallic dimethacrylates; polyethylene glycol (1000) dimethacrylate; methacrylated polybutadiene; propoxylated2 neopentyl glycol diacrylate; ethoxylated30 bisphenol A dimethacrylate; ethoxylated30 bisphenol A diacrylate; alkoxylated neopentyl glycol diacrylates; polyethylene glycol dimethacrylates; 1,3-butylene glycol diacrylate; ethoxylated2 bisphenol A dimethacrylate; dipropylene glycol diacrylate; ethoxylated4 bisphenol A diacrylate; polyethylene glycol (600) diacrylate; polyethylene glycol (1000) dimethacrylate; propoxylated neopentyl glycol diacrylates such as propoxylated2 neopentyl glycol diacrylate; diacrylates of alkoxylated aliphatic alcohols; trimethylolpropane trimethacrylate; tris (2-hydroxyethyl) isocyanurate triacrylate; ethoxylated20 trimethylolpropane triacrylate; pentaerythritol triacrylate; ethoxylated3 trimethylolpropane triacrylate; propoxylated3 trimethylolpropane triacrylate; ethoxylated6 trimethylolpropane triacrylate; propoxylated6 trimethylolpropane triacrylate; ethoxylated9 trimethylolpropane triacrylate; alkoxylated trifunctional acrylate esters; trifunctional methacrylate esters; trifunctional acrylate esters; propoxylated3 glyceryl triacrylate; propoxylated5.5 glyceryl triacrylate; ethoxylated15 trimethylolpropane triacrylate; trifunctional phosphoric acid esters; trifunctional acrylic acid esters; pentaerythritol tetraacrylate; di-trimethylolpropane tetraacrylate; ethoxylated4 pentaerythritol tetraacrylate; pentaerythritol polyoxyethylene tetraacrylate; dipentaerythritol pentaacrylate; and pentaacrylate esters.

Suitable epoxy-functionalized actinically curable substances that can be used as component b) include, for example, 3,4-epoxycyclohexylmethyl-3′,4′-epoxycyclohexanecarboxylate, 2-(3,4-epoxycyclohexyl-5,5-spiro-3,4-epoxy)cyclohexane-1,4-dioxane, bis(3,4-epoxycyclohexylmethyl)adipate, vinylcyclohexene oxide, 4-vinylepoxycyclohexane, bis(3,4-epoxy-6-methylcyclohexylmethyl)adipate, 3,4-epoxy-6-methylcyclohexyl-3′,4′-epoxy-6′-methylcyclohexanecarboxylate, methylenebis(3,4-epoxycyclohexane), dicyclopentadiene diepoxide, di(3,4-epoxycyclohexylmethyl) ether of ethylene glycol, ethylenebis(3,4-epoxycyclohexanecarboxylate), epoxyhexahydrodioctylphthalate, epoxyhexahydro-di-2-ethylhexyl phthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, polyglycidyl ethers of polyether polyol obtained by the addition of one or more alkylene oxides to aliphatic polyhydric alcohols such as ethylene glycol, propylene glycol, and glycerol, diglycidyl esters of aliphatic long-chain dibasic acids, monoglycidyl ethers of aliphatic higher alcohols, monoglycidyl ethers of phenol, cresol, butyl phenol, or polyether alcohols obtained by the addition of alkylene oxide to these compounds, glycidyl esters of higher fatty acids, epoxidized soybean oil, epoxybutylstearic acid, epoxyoctylstearic acid, epoxidized linseed oil, epoxidized polybutadiene, and the like.

Other examples of cationically polymerizable organic substances which can be used in component b) include oxetanes such as 3-ethyl-3-oxetanemethanol, trimethylene oxide, 3,3-dimethyloxetane, 3,3-di chloro methyl oxetane, 3-ethyl-3-pheno xymethyl oxetane, bis(3-ethyl-3-methyloxy)butane; oxolanes such as tetrahydrofuran 2,3-dimethyltetrahydrofuran, and mixtures thereof.

Other actinically curable monomers may be included in component b). Non-limiting examples are, e.g., α-methylstyrene, 2-methylstyrene, 3-methylstyrene, 4-methylstyrene, 4-propylstyrene, 4-t-butylstyrene, 4-cyclohexylstyrene, 4-dodecylstyrene, 2,4-dimethylstyrene, 2,4-diisopropylstyrene, 2,4,6-trimethylstyrene, 2-ethyl-4-benzylstyrene, 4-(phenylbutyl)styrene, 1-vinylnaphthalene, 2-vinylnaphthalene, vinylanthracene, N,N-diethyl-4-aminoethylstyrene, vinylpyridine, 4-methoxystyrene, monochlorostyrene, dichlorostyrene, divinylbenzene, and combinations thereof.

c) Opaque Reinforcement:

The term “opaque” as used herein in reference to the reinforcement should be understood to mean a reinforcement which blocks all or substantially all radiation across the UV and visible wavelengths. The term “reinforcements” would be recognized to be synonymous with the term “fillers.”

As discussed above, certain reinforcements may be opaque, transparent, or partially transparent to the energy from an energy source used for curing. Mixtures of more than one reinforcement are within the scope of the invention, including embodiments of the invention having some opaque and some transparent reinforcements and/or some partially transparent reinforcements. Those skilled in the art will recognize that, depending upon such factors as physical form or method of synthesis, certain reinforcements may be either UV opaque or UV transparent or be partially UV transparent. Mixtures of more than one reinforcement are within the scope of the invention.

Exemplary opaque reinforcements include chopped, or continuous fibers available in any conventional form such as tow, braided, unidirectional, woven fabric, knitted fabric, swirl fabric, felt mat, wound, and the like. Such carbon fiber is usually based on polyacrylonitrile or pitch-type

The carbon fiber may be surface treated with plasma, nitric acid or nitrous acid or similar strong acids, and/or further be surface functionalized (often referred to as “sized” or “sizing”) with agents such as but not limited to dialdehydes, epoxies, vinyl and other functional groups that would enhance adhesion of the carbon fiber to the cured polymer matrix.

Non-limiting examples of other UV opaque reinforcements may include chopped carbon fiber, carbon black, graphite, graphite felt, graphite foam, graphene, resorcinol-formaldehyde blends, polyacrylonitrile, rayon, petroleum pitch, natural pitch, resoles, carbon nanotubes, carbon soot, creosote, SiC, boron, WC, butyl rubber, boron nitride, fumed silica, nanoclay, silicon carbide, boron nitride, zirconium oxide, titanium dioxide, chalk, calcium sulfate, barium sulfate, calcium carbonate, silicates such as talc, mica or kaolin, silicas, aluminum hydroxide, magnesium hydroxide, or organic reinforcements such as polymer powders, polymer fibers, or the like, and mixtures thereof.

The opaque reinforcement may include continuous fiber. As used herein, continuous means having an aspect ratio (V) defined as length l divided by diameter d (l/d) greater than 100, 100, 3500, 1,000,000 or even larger. The opaque reinforcement may include chopped fiber, i.e. having an aspect ratio smaller than that of the continuous fiber.

The fiber may include carbon fibers, ceramic fiber, asbestos, Kevlar fiber, polybenzimidazole fiber, polysulforamide fiber, glass fiber, poly(phenylene oxide fiber, vegetable fibers, wood fibers, mineral fibers, plastic fibers, metallic wires, optical tubes, and/or aramid fiber. Carbon fiber is preferred and continuous carbon fiber is most preferred. Carbon fiber or other fiber(s) may be surface treated (plasma) or “sized” with an appropriate coupling agent such as nitric acid, glutaric dialdehyde or silanes for example.

Carbon fiber, polyacrylonitrile fiber, or rayon fiber may be straight or woven and vary in fiber diameter and density. The fibers or co-fiber may have a varied fiber-volume-fractions from 20-90%. Mixtures of fibers, whether continuous or chopped are contemplated. For example carbon fiber may be commodified with ceramic fiber, asbestos fiber, Kevlar fiber, polybenzimidazole fiber, polysulforamide fiber, glass fiber, vegetable fibers, wood fibers, mineral fibers, plastic fibers, metallic wires, optical tubes, and/or aramid fiber.

Particulate reinforcements may also be included. Non-limiting examples are graphite; ceramics e.g. high temperature ceramics such as SiC/boron; nanosilicas; boron nitride; nanoclays; carbon soot; fly ash; coke; carbon, graphite; glassy carbon; amorphous carbon; pitch; non-graphitic powder; carbon black, and mixtures thereof.

The c) at least one opaque reinforcement may include particles and may be present in an amount of at least 0.50% by weight of the curable composition prior to cure and pyrolysis. For example, the actinically curable compositions may include at least 0.6%, 0.7%, 0.8%, 1%, 1.5%, 2%, 3%, 4%, 5%, 6%, 7%, 8%, 9%, 10%, 20%, 30%, 40%, 50%, 60%, 70%, 80% or at least 90% by weight of particulate reinforcement. Up to 1% by weight of particulate reinforcement, if present is preferred.

The c) at least one opaque reinforcement may include fibers and may be present in an amount of at least 0.50% by weight of the curable composition prior to cure and pyrolysis. For example, the actinically curable compositions may include at least 1%, 2%, 3%, 4%, 5%, 6%, 7%, 8%, 9%, 10%, 20%, 30%, 40%, 50%, 60%, 70%, 80% or at least 90% by weight of fibers.

The c) at least one opaque reinforcement may include continuous fibers and may be present in an amount of at least 0.50% by weight of the curable composition prior to cure and pyrolysis. For example, the actinically curable compositions may include at least 1%, 2%, 3%, 4%, 5%, 6%, 7%, 8%, 9%, 10%, 20%, 30%, 40%, 50%, 60%, 70%, 80% or at least 90% by weight of continuous fibers.

The c) at least one opaque reinforcement may include continuous carbon fibers and may be present in an amount of at least 0.50% by weight of the curable composition prior to cure and pyrolysis. For example, the actinically curable compositions may include at least 1%, 2%, 3%, 4%, 5%, 6%, 7%, 8%, 9%, 10%, 20%, 30%, 40%, 50%, 60%, 70%, 80% or at least 90% by weight of continuous carbon fibers.

d) Photoinitiator:

In certain embodiments of the invention, the actinic radiation-curable compositions described herein include at least one photoinitiator and are curable with radiant energy (visible light and/or ultraviolet light). A photoinitiator may be considered any type of substance that, upon exposure to radiation (e.g., actinic radiation), forms species that initiate the reaction and curing of polymerizing organic substances present in the curable composition. Suitable photoinitiators include only free radical photoinitiators, only cationic photoinitiators, or combinations of both radical photoinitiators and cationic photoinitiators.

Free radical polymerization initiators are substances that form free radicals when irradiated. The use of free radical photoinitiators is especially preferred.

The photoinitiator may be a phosphine oxide, in particular a mono- or diacylphosphine oxide. Non-limiting examples of diacylphosphine oxides include: phenylbis(2,4,6-trimethylbenzoyl)phosphine oxide). Non-limiting examples of suitable acylphosphine oxides include, but are not limited to, 2,4,6-trimethylbenzoyl-diphenyl-phosphine oxide, bis(2,4,6-trimethylbenzoyl)-phenyl phosphine oxide, bis(2,4,6-trimethylbenzoyl)-(2,4-bis-pentyloxyphenyl)phosphine oxide, and 2,4,6-trimethyl-benzoylethoxyphenylphosphine oxide and combinations thereof.

When the curable composition contains organic substances containing polymerizable (reactive) ethylenically unsaturated functional groups such as (meth)acrylate functional groups, the use of free radical photoinitiators is especially preferred. Non-limiting types of free radical photoinitiators suitable for use in the curable compositions of the present invention include, for example, benzoins, benzoin ethers, acetophenones, benzyl, benzyl ketals, anthraquinones, phosphine oxides, α-hydroxyketones, phenylglyoxylates, α-aminoketones, benzophenones, thioxanthones, xanthones, acridine derivatives, phenazene derivatives, quinoxaline derivatives and triazine compounds. Examples of particular suitable free radical photoinitiators include, but are not limited to, 2-methylanthraquinone, 2-ethylanthraquinone, 2-chloroanthraquinone, 2-benzyanthraquinone, 2-t-butylanthraquinone, 1,2-benzo-9,10-anthraquinone, benzyl, benzoins, benzoin ethers, benzoin, benzoin methyl ether, benzoin ethyl ether, benzoin isopropyl ether, alpha-methylbenzoin, alpha-phenylbenzoin, Michler's ketone, acetophenones such as 2,2-dialkoxybenzophenones and 1-hydroxyphenyl ketones, benzophenone, 4,4′-bis-(diethylamino) benzophenone, acetophenone, 2,2-diethyloxyacetophenone, diethyloxyacetophenone, 2-isopropylthioxanthone, thioxanthone, diethyl thioxanthone, 1,5-acetonaphthylene, ethyl-p-dimethylaminobenzoate, benzil ketone, α-hydroxy keto, 2,4,6-trimethylbenzoyldiphenyl phosphine oxide, benzyl dimethyl ketal, 2,2-dimethoxy-1,2-diphenylethanone, 1-hydroxycylclohexyl phenyl ketone, 2-methyl-1-[4-(methylthio) phenyl]-2-morpholinopropanone-1,2-hydroxy-2-methyl-1-phenyl-propanone, oligomeric α-hydroxy ketone, benzoyl phosphine oxides, phenylbis(2,4,6-trimethylbenzoyl)phosphine oxide, ethyl-4-dimethylamino benzoate, ethyl(2,4,6-trimethylbenzoyl)phenyl phosphinate, anisoin, anthraquinone, anthraquinone-2-sulfonic acid, sodium salt monohydrate, (benzene) tricarbonylchromium, benzil, benzoin isobutyl ether, benzophenone/1-hydroxycyclohexyl phenyl ketone, 50/50 blend, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, dibenzosuberenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone, 50/50 blend, 4′-ethoxyacetophenone, 2,4,6-trimethylbenzoyldiphenylphophine oxide, phenyl bis(2,4,6-trimethyl benzoyl)phosphine oxide, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, (cumene)cyclopentadienyl iron(ii) hexafluorophosphate, 9,10-diethoxy and 9,10-dibutoxyanthracene, 2-ethyl-9,10-dimethoxyanthracene, thioxanthen-9-one and combinations thereof.

Suitable cationic photoinitiators include any type of photoinitiator that, upon exposure to radiation such as actinic radiation, forms cations (e.g., Brönsted or Lewis acids) that initiate the reaction of the monomeric and (if present) oligomeric polymerizing organic substances in the curable composition. For example, a cationic photoinitiator may be comprised of a cationic portion and an anionic portion. The cationic portion of the photoinitiator molecule can be responsible for the absorption of UV radiation while the anionic portion of the molecule becomes a strong acid after UV absorption. Suitable cationic photoinitiators include, for example, onium salts with anions of weak nucleophilicity, such as halonium salts, iodonium salts (e.g., diaryliodonium salts such as bis(4-t-butylphenyl) iodonium perfluoro-1-butane sulfonate) or sulfonium salts (e.g., triarylsulfonium salts such as triarylsulfonium hexafluoroantimonate salts); sulfoxonium salts; and diazonium salts. Metallocene salts are another type of suitable cationic photoinitiator.

The amount of photoinitiator in the compositions may be varied as may be appropriate depending upon the particular photoinitiator(s) selected, the amounts and types of polymerizing organic substances (monomeric and oligomeric) present in the curable composition, the radiation source and the radiation conditions used, among other factors. Typically, however, the amount of photoinitiator may be from 0.05% to 5%, preferably 0.1% to 2% by weight, based on the total weight of the curable composition, excluding reinforcement. According to some embodiments, typical concentrations of the photoinitiator may be up to about 15% by weight based on the total weight of the curable composition, excluding the reinforcement. For example, the actinic radiation-curable composition may comprise from 0.1 to 10% by weight, in total, of photoinitiator, based on the total weight of the curable composition, excluding the reinforcement.

Thermal Initiators:

In some embodiments, the curable compositions described herein further include, in addition to the photoinitiator, at least one free radical initiator that decomposes when heated and thus also cures the composition chemically (i.e., in addition to exposing the curable composition to radiation). The at least one free radical initiator may be referred to herein as a thermal initiator. The thermal initiator that decomposes when heated or in the presence of an accelerator may, for example, comprise a peroxide or azo compound, in particular an organic peroxide or an azonitrile. Suitable peroxides for this purpose may include any compound, in particular any organic compound, that contains at least one peroxy (—O—O—) moiety, such as, for example, dialkyl, diaryl and aryl/alkyl peroxides, hydroperoxides, percarbonates, peresters, peracids, acyl peroxides and the like. An example of an azonitrile is azobisisobutyronitrile (AIBN). The at least one accelerator may comprise, for example, at least one tertiary amine and/or one or more other reducing agents based on M-containing salts (such as, for example, carboxylate salts of transition M-containing salts such as iron, cobalt, manganese, vanadium and the like and combinations thereof). The accelerator(s) may be selected so as to promote the decomposition of the thermal initiator at room or ambient temperature to generate active free radical species, such that curing of the curable composition is achieved without having to heat or bake the curable composition. In other embodiments, no accelerator is present and the curable composition is heated to a temperature effective to cause decomposition of the thermal initiator and to generate free radical species which initiate curing of the polymerizable compound(s) present in the curable composition. Without wishing to be bound by theory, according to some embodiments, the exotherm provided by the photo-induced polymerization provides enough heat to decompose such chemical (thermal) free radical initiators.

The concentration of thermal initiator in the actinically curable compositions of the present disclosure may be varied as desired depending upon the particular compound(s) selected, the type or types of polymerizable compound(s) present in the actinically curable composition, the curing conditions utilized, and the rate of curing desired, among other possible factors. Typically, however, the actinically-curable composition may further include from 0.05% to 5%, preferably 0.1% to 2% by weight of the thermal initiator, based on the total weight of the curable composition, excluding reinforcement. According to some embodiments, typical concentrations of the thermal initiator may be up to about 15% by weight based on the total weight of the curable composition, excluding the reinforcement. For example, the actinic radiation-curable composition may comprise from 0.1 to 10% by weight, in total, of thermal initiator, based on the total weight of the curable composition, excluding the reinforcement.

Other Additives:

The curable composition may further include at least one non-curable char-forming constituent, selected from the group consisting of tar pitches, petroleum products, non-functionalized novolaks, carbore, lignin, pitch, lignite, tar, creosote, and mixtures thereof.

These actinic radiation curable compositions may further include other non-reactive additives, that may or may not contribute to forming the char. Non-limiting examples are carbon felts, fiberform insulation to create “phenolic impregnated carbon ablators (PICAs)” as greater performing materials having lower thermal conductivity, lower density, but higher effective heat of ablation. These (non-reactive) phenolic resins may themselves include graphite additives to form graphite-based phenolic ablatives.

Non-reactive additives may also include acrylonitrile butadiene rubber (BNR), and ethylene propylene diene monomer rubber (EPDM), and/or aramids, for example. As is known in the art, elastomers may optionally be included in the actinically curable compositions disclosed here. Typically these are used to impart flexibility to the composite during the pyrolysis step, in order to prevent residual stress due to volatiles that are unable to escape. The flexibility also helps minimize undesirable residual stress due to thermal stresses caused by the pyrolysis and subsequent cooling of the part. Non-limiting examples of such additives include dissolved or particulate acrylonitrile butadiene rubber (BNR), and ethylene propylene diene monomer rubber (EPDM).

Since uniform and non-encapsulated porosity is a desirable attribute of the composite structure after the pyrolysis process, pore-forming agents may optionally be included. Typically, these are substances that volatile in a controlled manner during the pyrolysis process, to prevent and minimize undesirable trapped volatiles resulting from pyrolysis of the cured inventive composition as it forms the carbon matrix. Non-limiting examples include plasticizers such as ethylenebis(stearamide), stearic acid, oleic acid, any and all glycols, and mixtures thereof. Other non-limiting examples include: avocado oil, almond oil, olive oil, cacao oil, beef tallow, sesame oil, wheat germ oil, safflower oil, shea butter, turtle oil, persimmon oil, persic oil, castor oil, grape oil, macadamia nut oils such as mink oil, egg yolk oil, owl, palm oil, rosehip oil, hydrogenated oil; wax such as orange luffy oil, carnauba wax, candelilla wax, whale wax, jojoba oil, montan wax, beeswax, lanolin, lanolin hydrocarbons such as liquid paraffin, petrolatum, paraffin, ceresin, microcrystalline wax, squalane; lauric acid, myristic acid, palmitic acid, stearic acid, oleic acid, behenic acid, undecylenic acid, oxystearic acid, linoleic acid, lanolin fatty acid, higher fats such as synthetic fatty acids, higher alcohols such as lauryl alcohol, cetyl alcohol, cetostearyl alcohol, stearyl alcohol, oleyl alcohol, behenyl alcohol, lanolin alcohol, hydrogenated lanolin alcohol, octyldodecanol and isostearyl alcohol; sterols such as cholesterol, dihydrocholesterol and phytosterol; linoleic acid ester, isopropyl myristate, lanolin fatty acid isopropyl, hexyl laurate, myristyl myristate, cetyl myristate, octyldodecyl myristate, decyl oleate, octyldodecyl oleate, hexyldecyl dimethyloctanoate, cetyl isooctanoate, palmitic acid cetyl, trimyristin glycerin, tri (capryl/capric acid) catty acid esters such as glycerol, propylene glycol dioleate, glycerol triisostearate, glycerol triisooctanoate, cetyl lactate, myristyl lactate, diisostearyl malate; polyhydric alcohols such as ethylene glycol, propylene glycol, trimethylene glycol, 1,2-butylene glycol, 1,3-butylene glycol, tetramethylene glycol, 2,3-butylene glycol, pentamethylene glycol, 2-butene-1,4-diol, hexylene glycol, octylene glycol and the like alcohol; trivalent alcohol such as glycerin, trimethylolpropane, 1,2,6-hexanetriol; tetravalent alcohol such as pentaerythritol; pentavalent alcohol such as xylitol hexavalent alcohols such as sorbitol and mannitol, polyhydric alcohols such as diethylene glycol, dipropylene glycol, triethylene glycol, polypropylene glycol, tetraethylene glycol, diglycerin, polyethylene glycol, triglycerin, tetraglycerin and polyglycerin copolymer; ethylene glycol monomethyl ether, ethylene glycol monoethyl ether, ethylene glycol monobutyl ether, ethylene glycol monophenyl ether, ethylene glycol monohexyl ether, ethylene glycol mono 2-methylhexyl ether, ethylene glycol isoamyl ether, ethylene glycol benzyl ether, ethylene diglycol isopropyl ether, ethylene glycol di-divalent alcohol alkyl ethers such as chill ether, ethylene glycol diethyl ether, ethylene glycol dibutyl ether; diethylene glycol monomethyl ether, diethylene glycol monoethyl ether, diethylene glycol monobutyl ether, diethylene glycol dimethyl ether, diethylene glycol diethyl ether, diethylene glycol butyl ether, diethylene glycol methyl ethyl ether, triethylene glycol ethylene glycol monomethyl ether, triethylene glycol monoethyl ether, propylene glycol monomethyl ether, propylene glycol monoethyl ether, propylene glycol monobutyl ether, propylene glycol isopropyl ether, dipropylene glycol dihydric alcohol alkyl ethers such as dimethyl ether, dipropylene glycol ethyl ether, dipropylene glycol butyl ether; ethylene glycol monomethyl ether acetate, ethylene glycol monoethyl ether acetate, ethylene glycol monobutyl ether acetate, ethylene glycol monophenyl ethyl acetate, ethylene glycol diazebate, ethylene glycol disuccinate, diethylene glycol monoethyl ether acetate, diethylene glycol monobutyl ether acetate, propylene glycol monomethyl ether acetate, propylene glycol monoethyl ether acetate, propylene glycol monopropyl ether acetate, propylene glycol mono dihydric alcohol ether esters such as phenyl ether acetate; Glycerin monoalkyl ethers such as xyl alcohol, ceralkyl alcohol, batyl alcohol, sorbitol, maltitol, maltotriose, mannitol, sucrose, erythritol, glucose, fructose, amylolytic sugar, maltose, xylitol, amylolytic sugar-reducing alcohols, glycolide, tetrahydrofurfuryl alcohol, POE tetrahydrofurfuryl alcohol, POP butyl ether, POP/POE butyl ether, tripolyoxypropylene glycerin ether, POP glycerin ether, POP, glycerin ether phosphoric acid and POP/POE pentaerythritol ether.

These compositions may further include a dual-initiator system, rather than simply relying on UV-initiation alone to produce free radicals and/or cations. Composed of both photoinitiators and thermal initiators, the dual-initiation system may utilize the polymerization exotherm generated from UV-initiation at the surface to initiate the thermal initiators beneath the UV-opaque reinforcements. The heat generated continues to propagate further into the depth of the resin/fiber layer in a frontal polymerization process. Non-limiting examples of suitable thermal initiators are azonitriles such as azobisisobutyronitrile (AIBN). Peroxides are also suitable thermal initiators, for example Luperox® A98 or Luperox LP® available from Arkema. Dicumyl peroxide is another non-limiting example.

These composition may further include at least one UV transparent reinforcement. For example, the UV transparent reinforcement may include glass, silica, fumed silica, alumina, zirconium oxide, nanoparticles, and mixtures thereof.

Additive Manufacturing Methods

The compositions of the present invention may be used with a variety of additive manufacturing systems and methods. In one embodiment, a method of making a three dimensionally printed carbon bonded composite article from the inventive actinically curable composition qualified in that the reinforcement has an aspect ratio of less than 100 using digital light projection, stereolithography or multi jet printing is provided.

The method includes:
irradiating the curable composition in a layer by layer manner to form a cured three dimensionally printed article; and
pyrolyzing the cured three dimensionally printed article to form the three dimensionally printed carbon bonded composite article.

### Aspects of the Invention

Certain non-limiting aspects of the invention are summarized below:

Aspect 1. A curable composition comprising:
a) at least one aromatic, actinically curable component having an H/C ratio of from 0.4 to 1.6, selected from the group consisting of (meth)acrylate oligomers, epoxy-functionalized compounds, and mixtures thereof;
b) at least one diluent comprising at least one actinically curable monomer;
c) an opaque reinforcement; and
d) a photoinitiator,
wherein the curable composition has a viscosity of at most 60,000 mPa·s at 25° C. and the composition creates more than 18 weight % char after curing as measured by thermogravimetric analysis after 3 hour hold at 400° C., based on the weight of a), b) and d) after actinally curing.

Aspect 2. The curable composition of Aspect 1 wherein the a) aromatic, actinically curable component has an H/C ratio of from 0.7 to 1.4.

Aspect 3. The curable composition of either Aspect 1 or Aspect 2 wherein the b) at least one diluent comprising at least one actinically curable monomer has an aromatic content of at least 1.

Aspect 4. The curable composition of any of Aspects 1-3, wherein the composition creates at least 20 weight % char after curing as measured by thermogravimetric analysis after 3 hour hold at 400° C., based on the weight of a), b) and d) after actinally curing.

Aspect 5. The curable composition of any of Aspects 1-4, wherein the composition creates more than 22.5 weight % char after curing as measured by thermogravimetric analysis after 3 hour hold at 400° C., based on the weight of a), b) and d) after actinally curing.

Aspect 6. The curable composition of any of Aspects 1-5, wherein the composition creates more than 25 weight % char after curing as measured by thermogravimetric analysis after 3 hour hold at 400° C., based on the weight of a), b) and d) after actinally curing.

Aspect 7. The curable composition of any of Aspects 1-6, wherein the a) aromatic, actinically curable component comprises a (meth)acrylated novolak.

Aspect 8. The curable composition of any of Aspects 1-7, wherein the combination of the a) at least one aromatic, actinically curable component and the b) at least one diluent comprising at least one actinically curable monomer has a net H/C ratio of from to 1.6.

Aspect 9. The curable composition of any of Aspects 1-8, wherein the a) aromatic, actinically curable component comprises at least one (meth)acrylate group per molecule.

Aspect 10. The curable composition of any of Aspects 1-8, wherein the a) aromatic, actinically curable component comprises at least two (meth)acrylate groups per molecule.

Aspect 11. The curable composition of any of Aspects 1-8, wherein the a) aromatic, actinically curable component comprises at least one epoxy group per molecule.

Aspect 12. The curable composition of any of Aspects 1-8, wherein the a) aromatic, actinically curable component comprises at least one epoxy group per molecule and at least one (meth)acrylate group per molecule.

Aspect 13. The curable composition of any of Aspects 1-8, wherein the a) aromatic, actinically curable component comprises a first compound comprising at least one epoxy group per molecule and a second compound comprising at least one (meth)acrylate group per molecule.

Aspect 14. The curable composition of any of Aspects 1-13, wherein the b) at least one diluent comprising at least one actinically curable monomer comprises at least one (meth)acrylate group per molecule.

Aspect 15. The curable composition of any of Aspects 1-13, wherein the b) at least one diluent comprising at least one actinically curable monomer comprises at least two (meth)acrylate groups per molecule.

Aspect 16. The curable composition of any of Aspects 1-13, wherein the b) at least one diluent comprising at least one actinically curable monomer comprises at least one epoxy group per molecule.

Aspect 17. The curable composition of any of Aspects 1-13, wherein the b) at least one diluent comprising at least one actinically curable monomer comprises at least one epoxy group per molecule and at least one (meth)acrylate group per molecule.

Aspect 18. The curable composition of any of Aspects 1-13, wherein the b) at least one diluent comprising at least one actinically curable monomer comprises a first compound comprising at least one epoxy group per molecule and a second compound comprising at least one (meth)acrylate group per molecule.

Aspect 19. The curable composition of any of Aspects 1-18, wherein the c) at least one opaque reinforcement comprises continuous carbon fibers.

Aspect 20. The curable composition of any of Aspects 1-19, wherein the c) at least one opaque reinforcement comprises continuous fibers.

Aspect 21. The curable composition of any of Aspects 1-20, wherein the c) at least one opaque reinforcement comprises particles and is present in an amount of at least 0.5% by weight of the curable composition prior to cure and pyrolysis.

Aspect 22. The curable composition of any of Aspects 1-21, wherein the c) at least one opaque reinforcement comprises a fiber and is present in an amount of at least 0.5% by weight of the curable composition prior to cure and pyrolysis.

Aspect 23. The curable composition of any of Aspects 1-22, wherein the composition further comprises at least one UV transparent reinforcement.

Aspect 24. The curable composition of any of Aspects 1-23, further comprising at least one thermal initiator.

Aspect 25. The curable composition of Aspect 1, wherein
a) is an acrylated epoxy novolak resin;
b) is selected from the group consisting of ethyoxylated3 bisphenol A diacrylate, 2-phenoxyethyl acrylate, tert-butylcyclohexyl acrylate, tricyclodecane dimethanol diacrylate, tris(2-hydroxy ethyl)isocyanurate triacrylate, polyoxyethylene p-cumylphenyl ether acrylate, trimethylolpropane triacrylate, and mixtures thereof;
d) is phenylbis(2,4,6-trimethylbenzolyl)phosphine oxide; and
the curable composition further comprises at least one thermal initiator comprising azobisisobutyronitrile.

Aspect 26. The curable composition of any of Aspects 1-25, further comprising at least one non-curable char-forming constituent, selected from the group consisting of tar pitches, petroleum products, non-functionalized novolaks, carbore, and mixtures thereof.

Aspect 27. A method of making a three dimensionally printed carbon bonded composite article using digital light projection, stereolithography or multi jet printing, comprising:
irradiating the actinically curable composition of any of Aspects 1-26 in a layer by layer manner to form a cured three dimensionally printed article, wherein the reinforcement has an aspect ratio of less than 100; and
pyrolyzing the cured three dimensionally printed article to form the three dimensionally printed carbon bonded composite article.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the actinic radiation-curable compositions, methods for making the actinic radiation-curable compositions, methods for using the actinic radiation-curable compositions, and articles prepared from the actinic radiation-curable compositions. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### Examples

The cured samples as shown in Tables 1 and 2 were prepared by first mixing the a), b) and d) components as shown in the tables. No reinforcements were used for the examples, since the char is exclusive of the reinforcement. Then, for each example, a droplet of the uncured liquid resin mixture was placed on a glass plate, placed underneath a UV flood lamp and cured with UV exposure for 30-60 seconds, then removed from the plate and cut into pieces small enough to fit in a thermogravimetric analysis (TGA) sample pan. The TGA analysis was used to simultaneously pyrolyze and measure the amount of char provided by the cured resin.

The weight % char of a small amount of cured material (10-30 mg of resin without reinforcement) was preferably measured using a TA Instruments Q50 TGA using the following heating procedure: ramp from room temperature to 300° C. at a ramp rate of ramp from 300° C. to 400° C. at 1° C./min, hold at 400° C. for 3 hours, ramp from 400° C. to 500° C. at 1° C./min, hold at 500° C. for 3 hours, and finally ramp from 500° C. to 1000° C. after which the experiment is ended. A continuous flow of 40-60 mL/min of nitrogen was used as an inert purge gas throughout the heating procedure. The weight % char at a given temperature can be determined as the percentage of residual material weight divided by the weight recorded at the start of the experiment. The weight % char of each material is reported after being held at 400° C. for 3 hours.

Thus, the weight percent of char provided by the inventive composition after cure and pyrolysis is reported as (weight ash from TGA)/(weight of the sample after cure and prior to pyrolysis (by TGA)— weight of reinforcement)*100. Weight percent char provided by the inventive composition after cure and pyrolysis will therefore include any other additives in the sample that contribute to char.

TABLE 1

| | Example | Example | Example | Example |
|---|---|---|---|---|
| Component: (wt %) | 1 | 2 | 3 | 4 |
| CN2602 mixture of 60% (by weight) | 50 | 100 | 50 | 50 |
| aromatic multifunctional acrylate | | | | |
| component a) having an H/C_{atomic} ratio of | | | | |
| 1.15 and 40% (by weight) aromatic | | | | |
| monoacrylate diluent monomer b) having | | | | |
| an aromatic content of 2 | | | | |
| CD590 aromatic monoacrylate diluent | 50 | | | |
| monomer b) having an aromatic content of 2 | | | | |
| SR349 diacrylate aromatic diluent | | | 50 | |
| monomer b) having an aromatic content of 2 | | | | |
| SR339 monoacrylate aromatic diluent | | | | 50 |
| monomer b) having an aromatic content of 1 | | | | |
| Net H/C_{atomic} ratio of combination of a) and | 1.14 | 1.15 | 1.13 | 1.12 |
| b), as listed above | | | | |
| Irgacure 819 photo initiator d) | 0.5 | 0.5 | 0.5 | 0.5 |
| Viscosity @25° C., mPa · s before cure | 3,516 | — | 13,568 | 295 |
| Viscosity @60° C., mPa · s before cure | — | 1,657 | — | — |
| TGA char yield, 400° C. hold (wt %) | 20.1 | — | 29.1% | 23.2% |
| TGA char yield, 500° C. hold (wt %) | 15.5 | — | 22.1% | 17.7% |
| TGA char yield, 800° C. hold (wt %) | 13.8 | 20.9% | 19.8% | 16.0% |
| H/C_{atomic} ratio component a) | 1.17 | 1.15 | 1.14 | 1.13 |
| aromatic content (AC) component a) | 3.6 | 3.6 | 3.6 | 3.6 |

TABLE 2

| | Example | Example | Example | Example | Example |
|---|---|---|---|---|---|
| Component: | 5 | 6 | 7 | 8 | 9 |
| SR833 non-aromatic diacrylate diluent | | | | 10.5 | |
| monomer b) | | | | | |
| SR368 non-aromatic triacrylate diluent | | | 10 | 4.5 | 9.2 |
| monomer b) | | | | | |
| CN112C60* mixture of 60% (by weight) | 50 | 60 | 55 | 60 | 53.4 |
| aromatic multifunctional acrylate | | | | | |
| component a) having an H/C_{atomic} ratio of | | | | | |
| 1.15 and 40% (by weight) non-aromatic | | | | | |
| triacrylate diluent monomer b) | | | | | |
| CD590 aromatic monoacrylate diluent | 50 | | | | |
| monomer b) having an aromatic content of 2 | | | | | |
| SR339 monoacrylate aromatic diluent | | 40 | 35 | 25 | 33.9 |
| monomer b) having an aromatic content of 1 | | | | | |
| SR340 aromatic monomethacrylate diluent | | | | | 2.5 |
| monomer b) having an aromatic content of 1 | | | | | |
| Net H/C_{atomic} ratio of combination of a) | 1.12 | 1.15 | 1.14 | 1.19 | 1.15 |
| and b), as listed above | | | | | |
| Irgacure 819 photo initiator d) | 0.5 | 0.5 | 0.5 | 0.5 | 0.5 |
| Luperox P thermal initiator | | | | | 0.5 |
| Viscosity @25° C., mPa · s before cure | 2,450 | 536 | 710 | 1,183 | 620 |
| Viscosity @60° C., mPa · s before cure | — | — | — | — | — |
| TGA char yield, 400° C. hold | 25.1% | 31.0% | 32.0% | 33.6% | 32.5% |
| TGA char yield, 500° C. hold | 19.0% | 23.2% | 22.7% | 23.6% | 24.1% |
| TGA char yield, 800° C. hold | 17.2% | 21.1% | 20.6% | 21.4% | 21.3% |
| H/C_{atomic} ratio component a) | 1.17 | 1.13 | 1.14 | 1.16 | 1.14 |
| aromatic content (AC) component a) | 3.6 | 3.6 | 3.6 | 3.6 | 3.6 |

*The term “acrylated epoxy novolak oligomer” means that the substance is derived from a ring-opened epoxidized composition. This material does not include epoxy groups.

1. A curable composition comprising:
a) at least one aromatic, actinically curable component having an H/C ratio of from 0.4 to 1.6, selected from the group consisting of (meth)acrylate oligomers, epoxy-functionalized compounds, oxetane-functionalized compounds, and mixtures thereof;
b) at least one diluent comprising at least one actinically curable monomer;
c) an opaque reinforcement; and
d) a photoinitiator.

2. The curable composition of claim 1, wherein the curable composition has a viscosity of at most 60,000 mPa·s at 25° C.

3. The curable composition of claim 1, wherein the a) comprises at least one aromatic, actinically curable component having a H/C ratio of from 0.7 to 1.4.

4. The curable composition of claim 1, wherein the b) comprises at least one diluent having an aromatic content of at least 1.

5. The curable composition of claim 1, wherein the composition creates more than 18% weight % char after curing as measured by thermogravimetric analysis after 3 hour hold at 400° C., based on the weight of a), b) and d) after actinically curing.

6. The curable composition of claim 1, wherein the a) aromatic, actinically curable component comprises a (meth)acrylated epoxy novolak resin.

7. The curable composition of claim 1, wherein the combination of the a) at least one aromatic, actinically curable component and the b) at least one diluent comprising at least one actinically curable monomer has a net H/C ratio of from 0.4 to 1.6.

8. The curable composition of claim 1, wherein the a) comprises at least one aromatic, actinically curable component comprising at least one (meth)acrylate group per molecule.

9. The curable composition of claim 1, wherein the a) comprises at least one aromatic, actinically curable component comprising at least two (meth)acrylate groups per molecule.

10. The curable composition of claim 1, wherein the a) comprises at least one aromatic, actinically curable component comprising at least one epoxy group and/or at least one oxetane group per molecule.

11. (canceled)

12. (canceled)

13. (canceled)

14. (canceled)

15. (canceled)

16. (canceled)

17. The curable composition of claim 1, wherein the b) at least one diluent comprises a first actinically curable monomer comprising at least one epoxy group and/or at least one oxetane group per molecule and a second actinically curable monomer comprising at least one (meth)acrylate group per molecule.

18. The curable composition of claim 1, wherein the c) at least one opaque reinforcement comprises carbon fibers.

19. The curable composition of claim 1, wherein the c) at least one opaque reinforcement comprises continuous fibers.

20. (canceled)

21. The curable composition of claim 1, wherein the c) at least one opaque reinforcement comprises a fiber and is present in an amount of at least 0.5% by weight of the curable composition.

22. The curable composition of claim 1, wherein the composition further comprises at least one UV transparent reinforcement.

23. The curable composition of claim 1, further comprising at least one thermal initiator.

24. The curable composition of claim 1, wherein
a) is an (meth)acrylated epoxy novolak resin;
b) is selected from the group consisting of an ethoxylated bisphenol A diacrylate, 2-phenoxyethyl acrylate, tert-butylcyclohexyl acrylate, tricyclodecane dimethanol diacrylate, tris(2-hydroxy ethyl)isocyanurate triacrylate, mono- or polyoxyethylene p-cumylphenyl ether acrylate, trimethylolpropane triacrylate, and mixtures thereof;
d) is a phosphine oxide; and
the curable composition further comprises at least one thermal initiator.

25. The curable composition of claim 1, further comprising at least one non-curable char-forming constituent, selected from the group consisting of tar pitches, petroleum products, non-functionalized novolaks, carbore, pitch, lignite, tar, creosote and mixtures thereof.

26. The curable composition of claim 1, further comprising at least one non-curable char-forming constituent which is lignin.

27. A method of making a three dimensionally printed carbon bonded composite article using digital light projection, stereolithography or multi jet printing, comprising:
irradiating the actinically curable composition of claim 1 in a layer by layer manner to form a cured three dimensionally printed article, wherein the reinforcement has an aspect ratio of less than 100; and
pyrolyzing the cured three dimensionally printed article to form the three dimensionally printed carbon bonded composite article.
